(19) United States
(12) Patent Application Publication
(10) Pub. No.: US 2025/0143484 A1
(43) Pub. Date: May 8, 2025

(54) 2 STAGE PADDLE ROTOR AND AUGER FEED WEIGHING SYSTEM

(71) Applicants: Geoffrey MACKAY, Ottawa (CA); THE AGGRESSIVE GOOD INC., Ottawa (CA)

(72) Inventors: Geoffrey MACKAY, Ottawa (CA); Christopher FALCONI, Ottawa (CA)

(21) Appl. No.: 18/835,374

(22) PCT Filed: Feb. 8, 2023
(86) PCT No.: PCT/CA2023/050166

§ 371 Date: Aug. 2, 2024

Related U.S. Application Data
(60) Provisional application No. 63/307,651, filed on Feb. 8, 2022.

(51) Int. Cl. A47F 1/035; G06Q 20/20

(52) U.S. Cl. CPC A47F 1/035; G06Q 20/204

(57) ABSTRACT

A system and method for a feed weighing system used for automated bulk product dispensing. The system comprises an airtight cartridge that utilizes a motorized paddle valve to control the flow of product into a secondary paddle feed weighing stage. Using a digital interface or a dispense button, consumers select a specified amount of bulk product to be dispensed (by weight, mass, volume or cost). The product is then dispensed into a receptacle container and the system calculates the quantity and corresponding cost that was dispensed into the receptacle container. Using an identification key system, consumers can activate the automatic dispensing system. The identification key may be used to track and store the user's dispensed bulk products. This information may be uploaded to a database that is later called upon at the time of checkout to tabulate the user's total cost of dispensed bulk products.

### CROSS REFERENCE TO RELATED APPLICATIONS

This application claims priority to and the benefit of U.S. Provisional Patent Application Ser. No. 63/307,651, entitled “2-STAGE PADDLE ROTOR AND AUGER FEED WEIGHING SYSTEM”, filed on Feb. 8, 2022, the disclosure of which is incorporated herein by reference in its entirety. This application is also a US national phase entry of PCT application PCT/CA2023/050166 entitled “2-STAGE PADDLE ROTOR AND AUGER FEED WEIGHING SYSTEM”, filed on Feb. 8, 2023, the disclosure of which is incorporated herein by reference in its entirety.

### BACKGROUND

The embodiments described herein relate to bulk product dispensing, and in particular, to automated bulk food dispensing.

Bulk food purchasing is common in retail and grocery shops. Currently bulk food purchasing in stores is manual. A consumer scoops, weighs, tags, and identifies their bulk food products using plastic or paper tags and weigh scales in the stores to determine the price that is to be paid for the consumer's food selection. In some cases, the consumer may not weigh the bulk product until reaching the cash register, or they may not know how much product they need by weight since the recipe they want to make may express the amount of ingredients required in another format such as cups, fluid ounces or litres.

This process leads to inaccurate and inefficient weighing methods and to consumers purchasing too much or too little product for their needs. This can lead to wastage or requiring additional trips for more ingredients. The current purchasing system for bulk products can lead to errors caused by the user, and inventory control may be compromised for the retailer. The current process can be time consuming and inaccurate as each step of the process is manually performed by the user. The current process can also be wasteful and may lead to cross contamination of food due to bacteria, consumers misplacing the scoops, consumers attempting to return product to the bins and due to product spilling out of the bags while manually filling with the scoop. An opportunity for fraud, intentional or unintentional, is present if a consumer mislabels a similar looking product. In addition, the consumer does not have any instant information about cost or quantity of the bulk food product they are purchasing. The current purchasing systems for bulk products leave the consumer with unknown quantities of the product until they reach the cash register, which means they may over or under spend unknowingly.

The current open-bin system used in most bulk food stores exposes product to the air resulting in loss of product freshness, oxidization of food product, loss of flavour and absorption of flavours and smells from other store products. While airtight lids could be added to the bins, the size of the bin and the need for consumers to physically reach their hands inside the bin with a scoop, will still result in high levels of contamination and air exchange and provides opportunity for the consumer to fail to re-seal the lid when they are done. A significant additional hazard is present with open or lidded systems whereby germs, contaminants or pathogens from a consumer can be deposited on the product through breathing or sneezing.

If the consumer changes their mind about purchasing the product, they may leave the bag of product somewhere else in the store, this inventory cannot be tracked to the person, nor can the inventory be returned to the bin. Therefore, this product must be wasted, and the cost of the product written off by the retailer or manufacturer. Manual filling of the bins by retailers can lead to spillage and poor estimating of bulk volume which in turn results in inaccuracies in-purchase and store room levels which can be costly to the retailer. Over or understocking can be a problem without immediate information related to quantities purchased, time of purchase and the lack of information available to measure total quantity and cost of waste.

An initial design for a 1 stage system consisting of a cartridge/container with built in auger feed system is disclosed in U.S. patent Ser. No. 16/912,989 filed on Dec. 13, 2021, entitled “Automated Bulk Product Dispenser” which is incorporated by reference in its entirety. According to this disclosure, the full cartridge and auger weighs roughly 30 kg and is mounted on loadcell to provide active weight feedback. It was determined since the system is used to sell product based on weight a certification from Measurements Canada must be acquired. The standards for Measurements Canada required an accuracy of 1 g for this classification of products with a maximum reading ratio 3000:1. This translates to a maximum allowable scale reading of 3 Kg, which is beyond the initial design constraints of the first system.

There is a desire to implement an improved bulk food dispensing system and method that provides for active product weight measurement and inventory information to adhere to appropriate standards. Specifically, there is a desire for maximum scale reading of 3 Kg.

### SUMMARY

A system and method for a feed weighing system used for automated bulk product dispensing. The system comprises an airtight cartridge that utilizes a rotational motorized paddle valve to control the flow of product into a secondary paddle feed weighing stage. Using a digital interface or a dispense button, consumers select a specified amount of bulk product to be dispensed (by weight, mass, volume, or cost). The product is then dispensed into a receptacle container and the system calculates the quantity and corresponding cost that was dispensed into the receptacle container. In alternate embodiment, instead of pre-selecting a quantity of product, the user may hold the button down until the system indicates that the desired quantity of product has been dispensed. This quantity may be pre-set to a specific desired quantity, or the user may release the button once a visual display indicates that the desired quantity has been reached. Using a personal identification key system, consumers can activate the automatic dispensing system. The identification key may be used to track and store the user's dispensed bulk products during a shopping session. This information may be uploaded to a database that is later called upon at the time of checkout to tabulate the user's total cost of dispensed bulk products. The system can also update an inventory database of the bulk products.

### BRIEF DESCRIPTION OF THE DRAWINGS

FIG. 1 is a line diagram of an exemplary food dispensing system.

FIG. 2 is a line diagram of a front view of the exemplary food dispensing module.

FIG. 3 is a line diagram of a right-side view of the exemplary food dispensing module.

FIG. 4 is a line diagram of a perspective view of an exemplary hopper feed system.

FIG. 5 is a line diagram of an exploded view of the exemplary hopper feed system.

FIG. 6 is a line drawing of a top plan view of an exemplary scale assembly.

FIG. 7 is a line drawing of a front and bottom view of the exemplary scale assembly.

FIG. 8 is a line drawing of an exploded view of the exemplary scale assembly.

FIG. 9 is line drawing of an exploded right-side view of the scale assembly.

FIG. 10 is a line drawing of right-side view of the hopper assembly and scale assembly.

FIG. 11 is a line drawing of a perspective view and front view of an exemplary front display panel.

FIG. 12 is line drawing of an exploded view of the exemplary front display panel.

FIG. 13 is a line drawing of a perspective view of an exemplary single pod paddle assembly with the cartridge assembly installed.

FIG. 14 is line drawing of a right-side view of the exemplary single pod paddle assembly.

FIG. 15 is line drawing of a front plan view of the exemplary single pod paddle assembly.

FIG. 16 is a line drawing of a perspective view of an exemplary single pod paddle assembly with the cartridge assembly un-installed.

FIG. 17 is line drawing of an exploded view of a single pod paddle assembly.

FIG. 18 is a line drawing illustrating hot swappable capability of the food dispensing system.

FIG. 19 is a perspective view of an alternate embodiment of a paddle feed system.

FIG. 20 is a right-side view of an alternate embodiment a paddle feed system.

FIG. 21 is a top plan view of an alternate embodiment a paddle feed system.

FIG. 22 is a front plan view of an alternate embodiment a paddle feed system.

FIG. 23 is an exploded view of an alternate embodiment a paddle feed system.

FIG. 24 is a block diagram illustrating components of a paddle feed system.

FIG. 25 is a state diagram illustrating dispensing activity of the system.

FIG. 26 is a state diagram illustrating dispensing Teensy microcontroller activity of the system.

FIG. 27 is a flow chart illustrating communication steps of the system.

FIG. 28 is a state diagram illustrating motor configuration.

### DETAILED DESCRIPTION

According to this disclosure, deficiencies in the initial screw design resulted in a redesign and disclosure of this 2-stage system that is outlined below. The 2-stage system is comprised of a cartridge that utilizes a motorized paddle valve to control the follow of product into a secondary auger feed weighing stage. During shipping, the cartridge can be fitted with an airtight seal to maintain the product freshness.

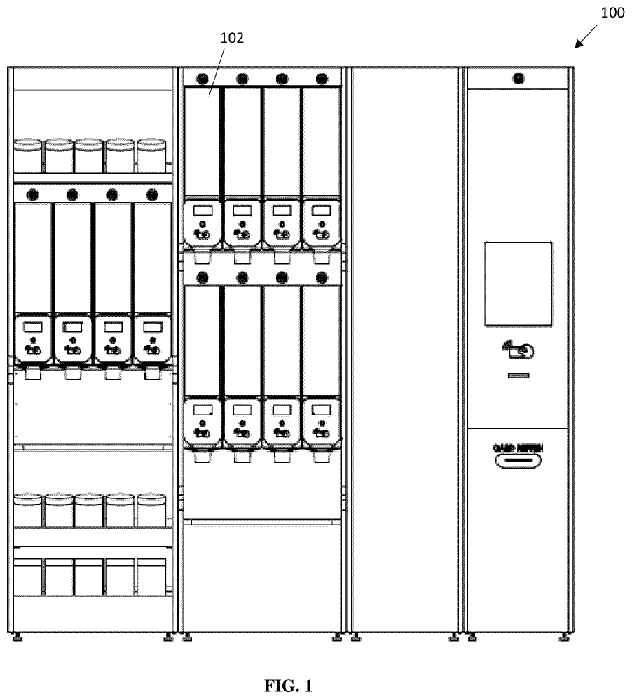

FIG. 1 is a line diagram of an exemplary food dispensing system. According to FIG. 1, food dispensing system 100 (or kiosk) consists of multiple food dispensing modules 102 (branded as TagPods). Food dispensing modules 102 can be used to dispense dry bulk foods such as nuts (e.g., walnuts, peanuts, cashews), grains (e.g., corn kernels, oats, flour), candies, potato chips and dry fruits (e.g., apricots, raisins, etc.).

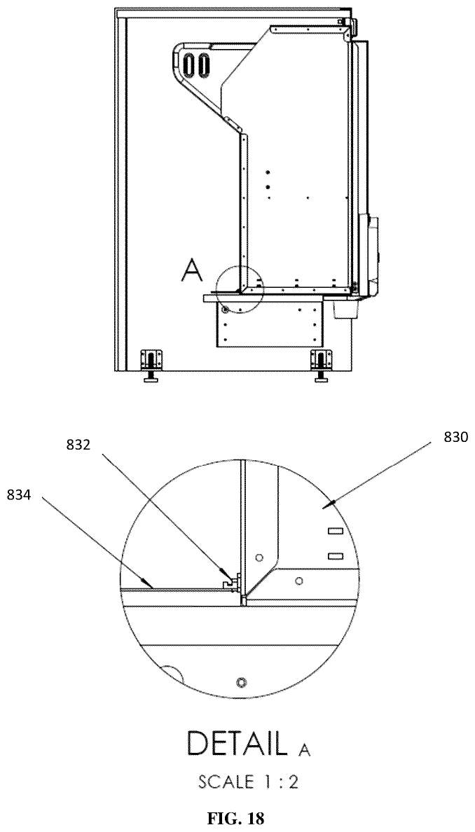

According to FIG. 1, food dispensing module 102 is modular, allowing for different orientations. The structure consists of a wood/composite frame/cabinet supported by aluminum bracing. Food dispensing module 102 (or TagPods) are connected and communicate with each other via modular power rail displayed in FIG. 18. Modular Power rail incudes power supply and a data bus such as I²S and handles communication between a master processor and one or more slave processors associated with each pod. The communication between the master processor and the online database is preferably facilitated through a Wi-Fi® module connected to the master processor, but it can be facilitated through one of many well known network connection means.

According to FIG. 1, the food dispensing system 100 consists of food dispensing modules 102 consisting of reusable cartridges to eliminate plastic waste and simplifies a zero-waste shopping experience. Each dispensing module consists of the following:
Internal Weighing system
Motorized dispensing
Inventory Tracking
Transaction information stored in online database using RFID membership card
Reusable RFID membership card tracks products taken from the dispensing system(s)

Components of a feed dispensing system consists of the following:

### Stage 1—Single Paddle Feed System

Reusable cartridge with handle and optional latching mechanism
Removable funnel with built in paddle rotor (paddle rotor removable for easy cleaning)
Paddle feed system is placed in TAGPOD and held in place using unique clasping mechanism.
Servo motor engages Paddle Feed system via hirth coupling that corrects rotational misalignment
Paddle Rotor has multiple flaps (e.g., 2-8) to ensure there is always a seal to stop product leakage

### Stage 2—Dual Paddle

Paddle feed system dispenses product into funnel hopper
Tare weight of hopper is taken with empty hopper to ensure accurate measurement of product
Paddle rotors made out of TPE over molded over POM shaft
3 kg Load Cell mounted to adjustable platform to allow for accurate leveling of weighing stage
Hopper housing is a 2 part design held together by 2 retainer rings
Diameter of paddle as well as number of fins can be changed to accommodate the properties of different dispensed products.

### Stage 2—Pre-Weigh System Auger

Paddle feed system dispenses product into funnel hopper and alternatively an auger housing
Auger is cast using food grade urethane around stainless steel shaft and hirth coupling
Auger is interchangeable to accommodate different pitches for changing granularities of product.
Auger mounted to removable bearing blocks and rotates on brass or UHMW bearings
Auger assembly removable from auger housing and fixed in place using tabs
Auger assembly is positioned on scale platform and fixed in place using 2 latches
Hopper held onto scale using 2 spring latch clips
Servo motor engages auger using hirth coupling.
Back stability latch counters rotor force applied by servo motor
Auger system released by handle positioned at front of scale platform
Anti-Jam fin developed to eliminate damage to product and eliminate jamming
3 kg Load Cell mounted to adjustable platform to allow for accurate leveling of weighing stage

More info on a feed dispensing system consists of the following:

### Stage 1—Single Paddle Feed System—Alternative Components

### Paddle Rotor

Knife valve
Centrifugal valve
Gravity fed gate

### Cartridge Mounting

Release handle with spring latch/spindle latch

### Motor Engagement

Jaw coupling
Rigid coupling

### Motors

Servo motors

### Stage 2—Pre-Weigh System—Alternative Components

Auger Case Mounting iterations
Spring clip
Elastic strap

### Motor Engagement

Jaw coupling
Rigid coupling

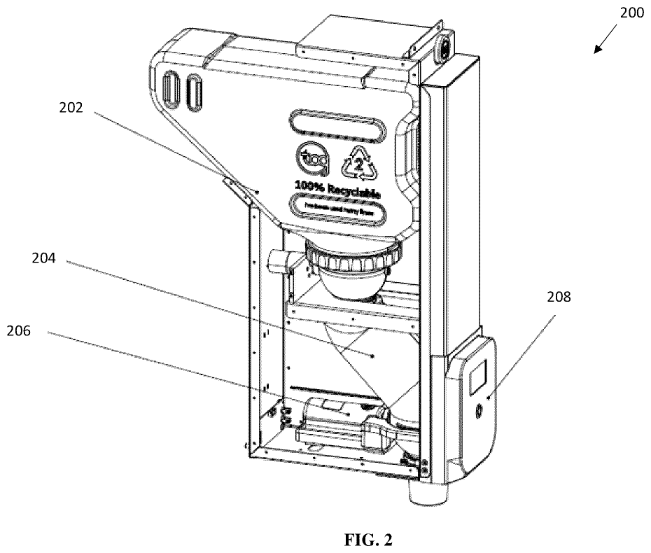

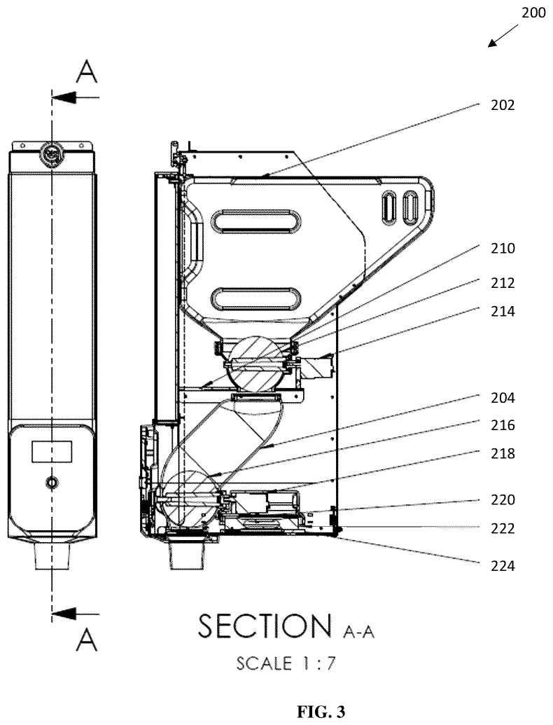

FIGS. 2 and 3 are diagrams illustrating an exemplary food dispensing module. According to FIGS. 2 and 3, food dispensing system consists of a paddle feed system and a feed leveling assembly and is constructed of an aluminum frame. The entire module is levelled using adjustable feet located on the bottom of the cabinet assembly.

FIG. 2 is a line diagram of a front view of the exemplary food dispensing module. According to FIG. 2, food dispensing module 200 consists of cartridge 202, feed hopper 204, scale 206 and front display 208.

FIG. 3 is a line diagram of a right-side view of the exemplary food dispensing module. FIG. 3 is a section view at section A-A with a scale of 1:7. According to FIG. 3, food dispensing module 200 shows a 2-stage paddle feed system. Food dispensing module 200 consists of cartridge 202, cartridge retainer 210, cartridge paddle rotor 212, cartridge motor 214, feed hopper assembly 204, feed paddle rotor 216, feed motor 218, strain gauge 220, load cell 222 and deflection limiter 224.

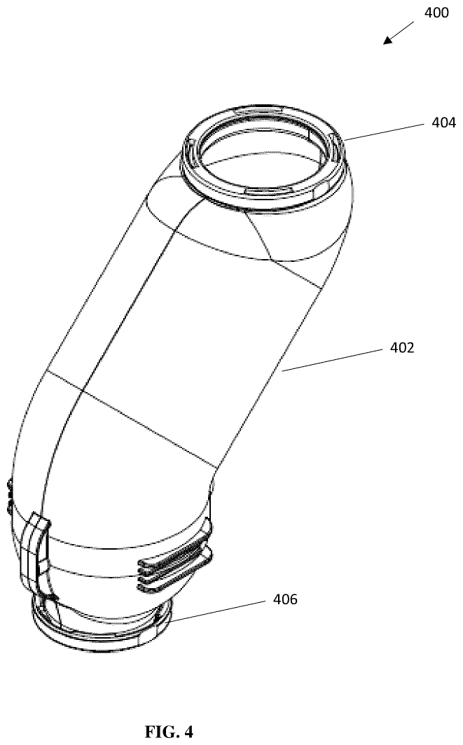

FIG. 4 is a line diagram of a perspective view of an exemplary hopper feed system. According to FIG. 4, hopper feed system 400 consists of feed hopper assembly 402, consisting of 2 outer shells held together with retainer rings 404, 406 located at the top and bottom of the hopper assembly 402.

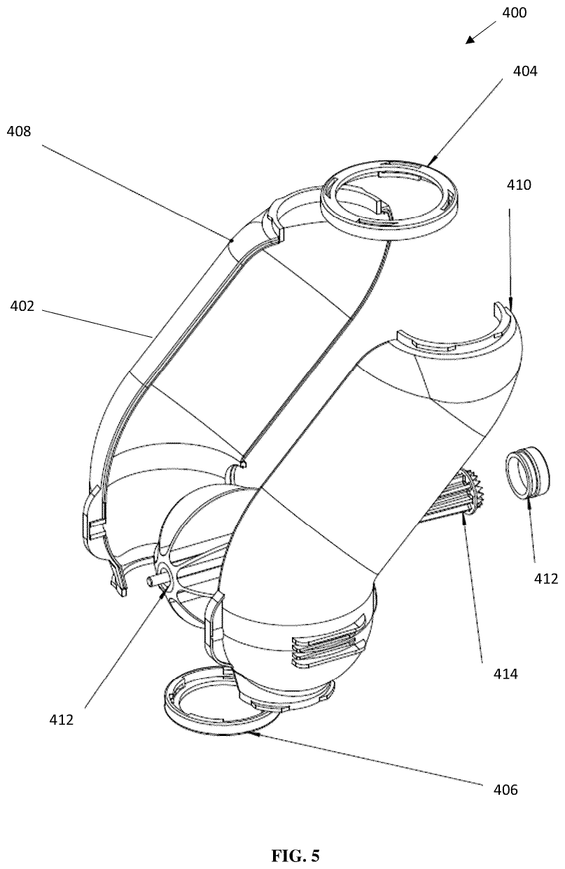

FIG. 5 is a line diagram of an exploded view of the exemplary hopper feed system. According to FIG. 5, hopper feed system 400 consists of hopper assembly 402, top retainer ring 404, bottom retainer ring 406, hopper shells 408 and 410, paddle rotor 412, paddle rotor shaft 414 and UHMW bearing 416.

According to FIG. 5, paddle rotor shaft 414 and UHMW bearing 416 is configured to connect to feed motor 218 (shown in FIG. 2) which provides power to turn the paddle rotor 412. Feed motor 218 can provide different power levels and different gyrating and pulse patterns that facilitate food movement or dispensing at different speeds (i.e., move fast, medium or slow) down the hopper assembly 402.

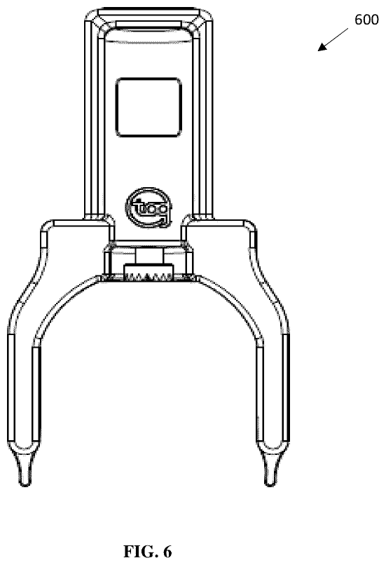

FIG. 6 is a line drawing of a top plan view of an exemplary scale assembly 600.

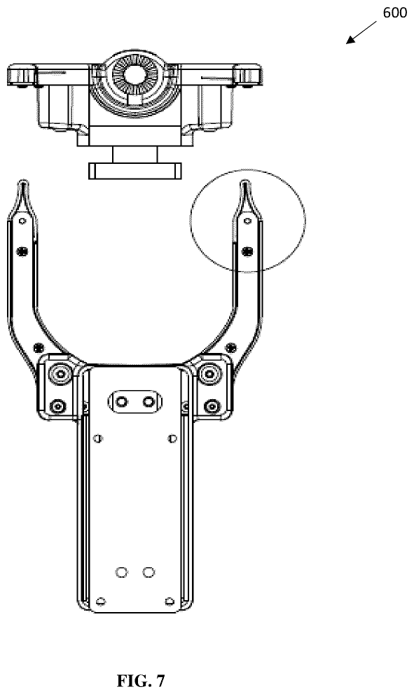

FIG. 7 is a line drawing of a front and bottom view of the exemplary scale assembly 600.

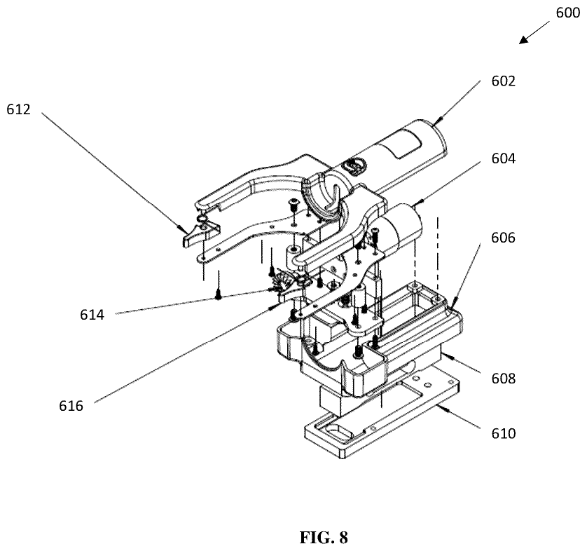

FIG. 8 is a line drawing of an exploded view of the exemplary scale assembly. According to FIG. 8, scale assembly 600 consists of a scale top cover 602, scale motor 604, scale bottom cover 606, scale load cell 608, deflection limiter 610, scale latch 612, hirth coupling mechanism 614 and latch mirror 616. Load cell 608 is enclosed to prevent product from interfering, hopper spring latch clips, hirth coupling mechanism 614 and deflection limiter 610 to prevent damage from applying too much force to the load cell 608.

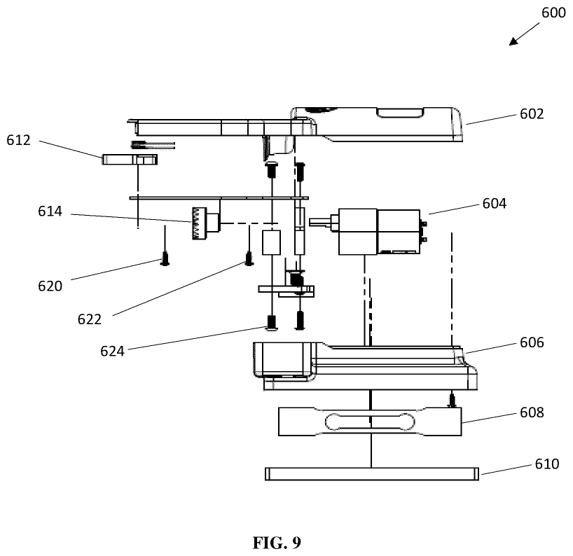

FIG. 9 is line drawing of an exploded right-side view of the scale assembly. According to FIG. 9, scale assembly 600 is also shown having scale top cover 602, scale motor 604, scale bottom cover 606, scale load cell 608, deflection limiter 610, scale latch 612 and hirth coupling mechanism 614.

According to FIG. 6, scale assembly 600 further comprises a plurality of bolts 620, 622 and 624 to secure the different components in place.

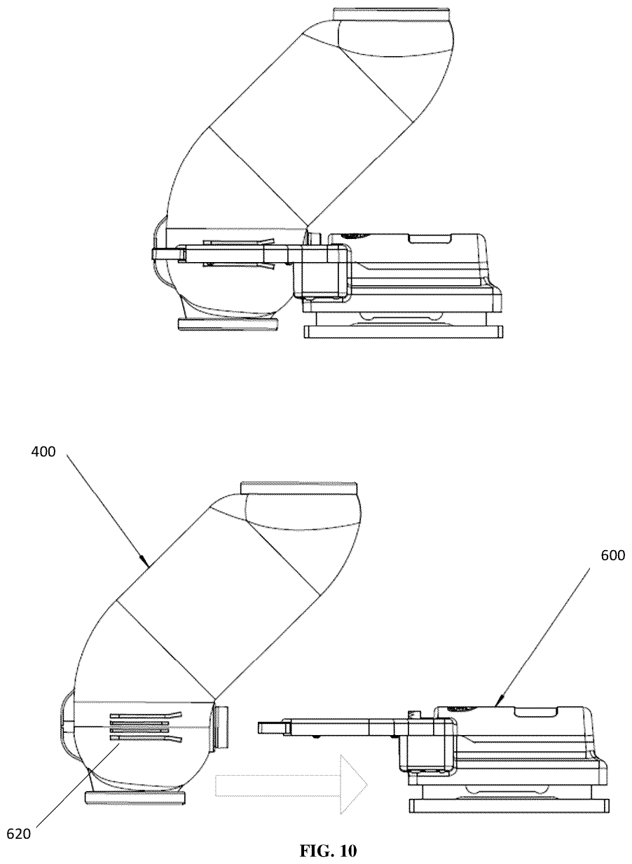

FIG. 10 is a line drawing of right-side view of the hopper assembly and scale assembly. According to FIG. 10, hopper assembly 400 can be removably latched or connected to scale assembly 600 through 2 spring latch clips 620.

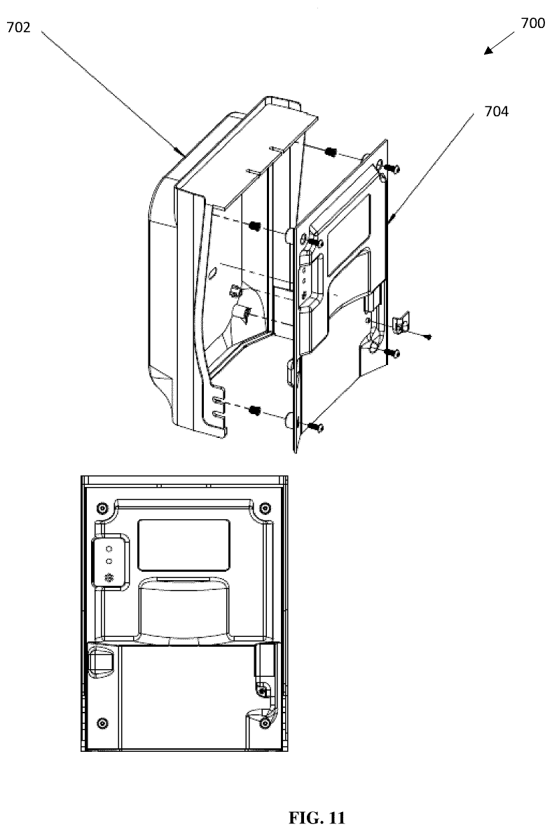

FIG. 11 is a line drawing of a perspective view and front view of an exemplary front display panel. According to FIG. 11, front display panel 700 includes a front face plate 702 and electronics cover 704.

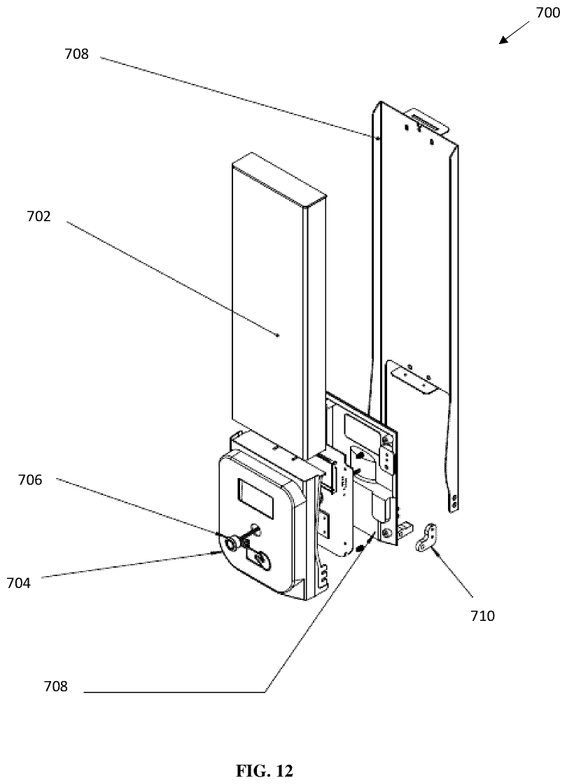

FIG. 12 is line drawing of an exploded view of the exemplary front display panel. According to FIG. 12, front display panel 700 includes front viewing window 702, face plate 704, button 706, electronics cover 704, back plate 708 and hinge 710. A user would push down on button 706 to dispense bulk food from the cartridge assembly.

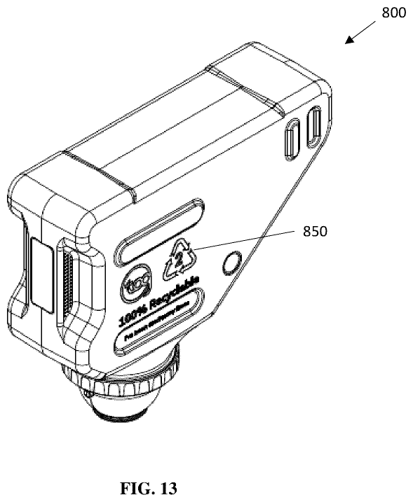

FIG. 13 is a line drawing of a perspective view of an exemplary single pod paddle assembly with the cartridge assembly installed.

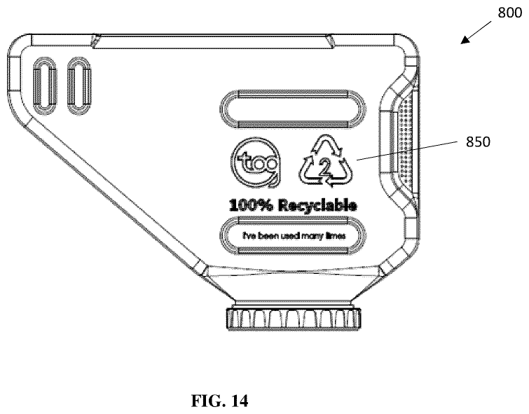

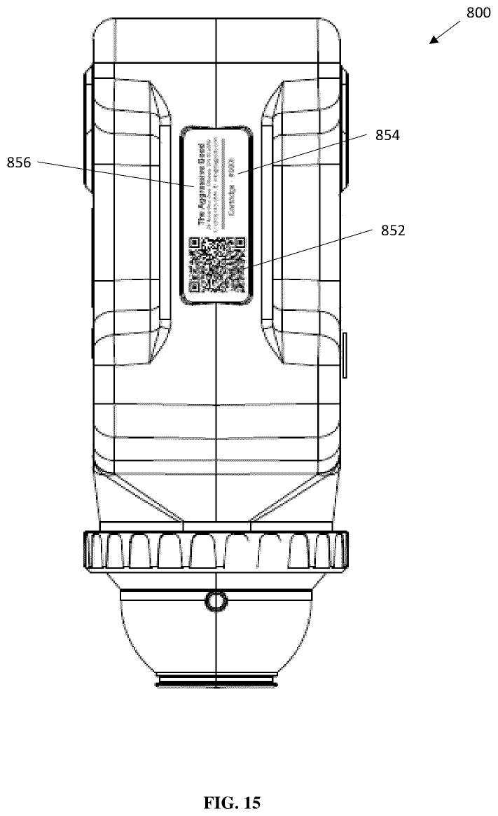

FIG. 14 is line drawing of a right-side view of the exemplary single pod paddle assembly. FIG. 15 is line drawing of a front plan view of the exemplary single pod paddle assembly.

According to FIGS. 13 to 15, cartridge assembly 800 is approximately 6 inches width by 12.5 inches height by 18 inches length and has a capacity to hold up to 15 liters of food. Cartridge assembly 800 is configured to dispense granular and/or dry bulk food (e.g., cereal, sugar, candy, etc.). In further embodiments, cartridge assembly 800 may be configured to dispense fluid or liquid food (e.g., peanut butter, honey, sauces, etc.)

Cartridge assembly 800 may also contain labels and/or stickers 850 that provides more information such as recycling logo, type of plastic, company logo, bar code 852, food product name, cartridge number or ID 854, and contact information 856. Preferably, a pod is labeled with a barcode that represents a product or Stock Keeping Unit (SKU) that is in the retailer's inventory management system, as well as a human readable description of the contents.

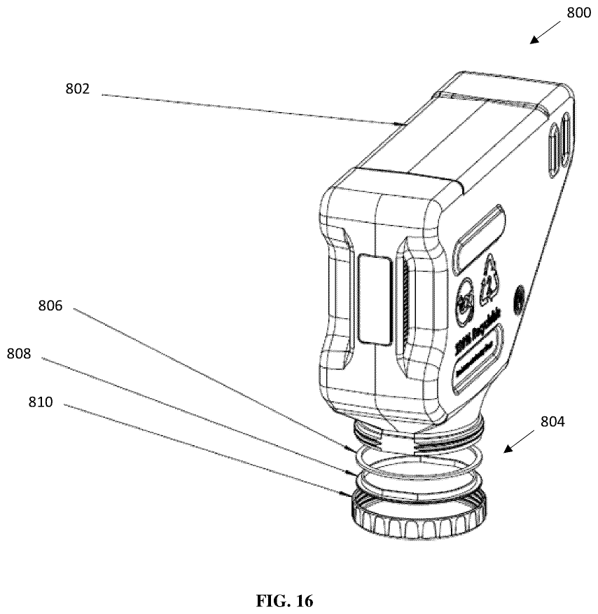

FIG. 16 is a line drawing of a perspective view of an exemplary single pod paddle assembly with the cartridge assembly un-installed. According to FIG. 16, single pod cartridge assembly 800 comprises cartridge 802 and air-tight seal 804. Air-tight seal 804 further comprises an O-ring 806, lid 808 and collar 810, wherein when assembled, creates an air-tight seal for cartridge 802.

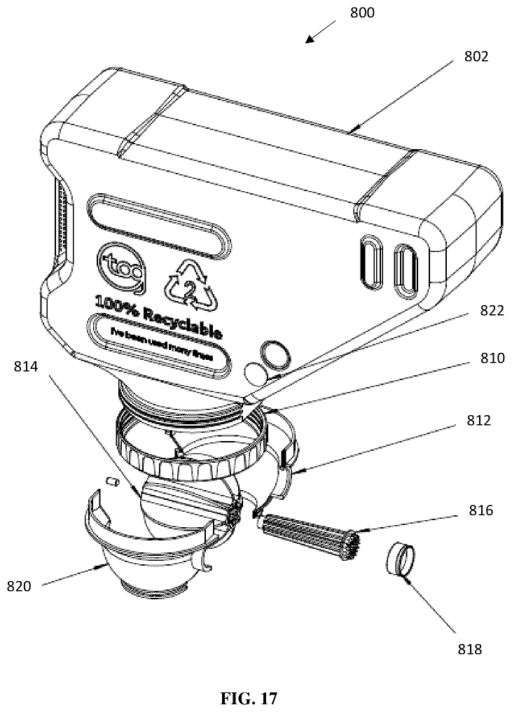

FIG. 17 is line drawing of an exploded view of the exemplary single pod paddle assembly. According to FIG. 17, single pod cartridge assembly 800 comprises cartridge 802, collar 810, paddle rotor holder mirror 812, paddle rotor 814, paddle rotor shaft 816, UHMW bearing 818 and paddle rotor holder 820.

According to FIG. 17, paddle rotor shaft 816 and UHMW bearing 818 is configured to connect to cartridge motor 214 (shown in FIG. 3) which provides power to turn the paddle rotor 814. Cartridge motor 214 can provide different power levels, impulses and different gyrating patterns that facilitate food dispensing at different speeds (i.e., move fast, medium or slow) from the cartridge assembly 800 to hopper assembly 400.

According to FIG. 17, one or more RFID tags 822 can be placed on cartridge assembly 800. RFID tag 822 enables cartridge assembly 800 to be registered with the system. RFID tag 822 consists of a unique identifier for each product type and enables the product (or more information) to be retrieved from the web application or interface. This reduces the potential for human error: accidentally placing a pod with the wrong contents into a dispensing slot.

FIG. 18 is a line drawing illustrating hot swappable capability of the food dispensing system. According to FIG. 18, an exploded view of section A is show, illustrating the ability for the food dispensing module (i.e., TagPod) to be hot swapped with another module. According to FIG. 18, the back of food dispensing module 830 (or TagPod) connects to blade connector 832 and power rail 834. When TagPod 830 is removed, the circuit is broken and the system will know that TagPod is removed. One preferred method of detecting a disconnected pod is to poll the pods periodically via the I²C bus, and noting when the pod does not respond. Once another TagPod 830 module is connected (i.e., circuit is completed again), the system will be put back online (i.e., turned back on for dispensing functionality).

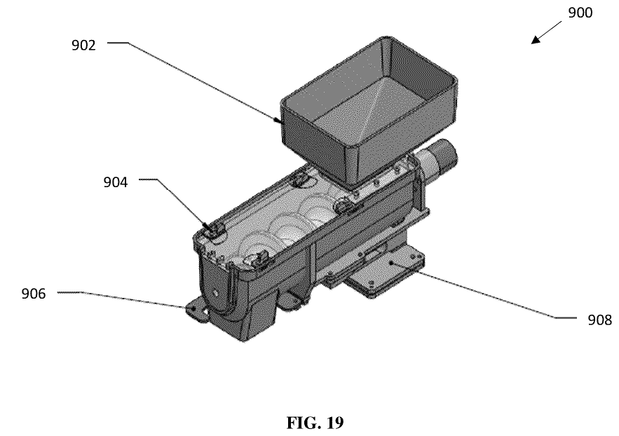

FIG. 19 is a perspective view of an alternate embodiment of a paddle feed system. According to FIG. 19, paddle feed system 900 comprises of a funnel hopper 902, auger housing tab 904, handle 906 and adjustable level platform 908. The auger feed system illustrated in FIG. 19 could be employed as an alternate feed mechanism to the bottom paddle dispensing mechanism in FIG. 3. The tubular weighing volume 204 can either be replaced or augmented by the weighing pan 902 in FIG. 19.

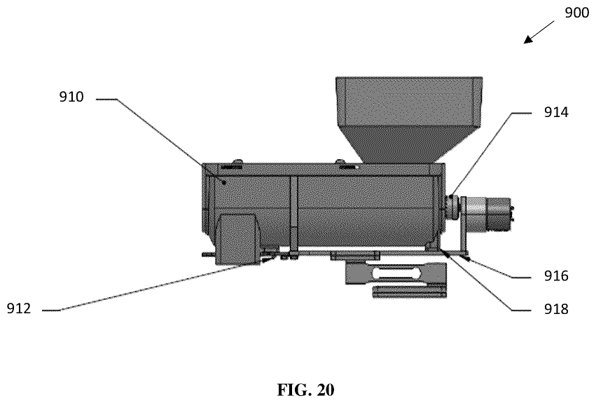

FIG. 20 is a right-side view of an alternate embodiment of a paddle feed system. According to FIG. 20, paddle feed system is shown to include an auger housing 910, latch 912, hirth coupling mechanism 914, scale platform 916 and stability latch 918.

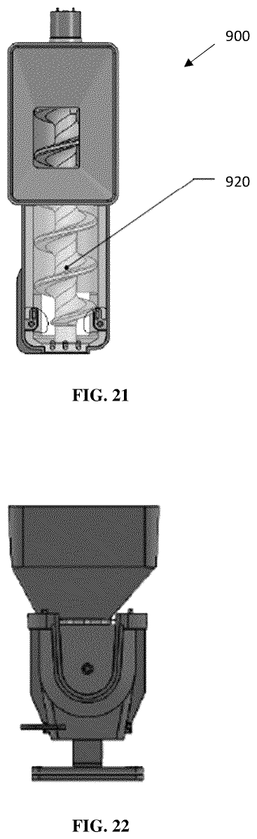

FIG. 21 is a top plan view of an alternate embodiment a paddle feed system. According to FIG. 21, paddle feed system further comprises auger shaft 920.

FIG. 22 is a front plan view of an alternate embodiment a paddle feed system.

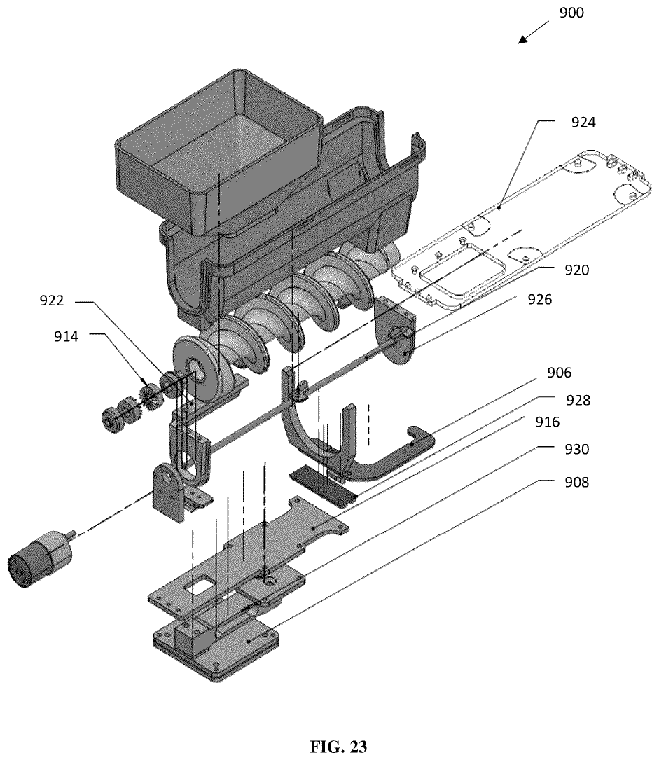

FIG. 23 is an exploded view of an alternate embodiment a paddle feed system. According to FIG. 23, paddle feed system 900 further comprises an anti-jam fin 922, hirth coupling mechanism 914, auger housing lid 924, auger shaft 920, bearing blocks 926, handle 906, steel spring 928, scale platform 916, strain gauge 930 and adjustable level platform 908.

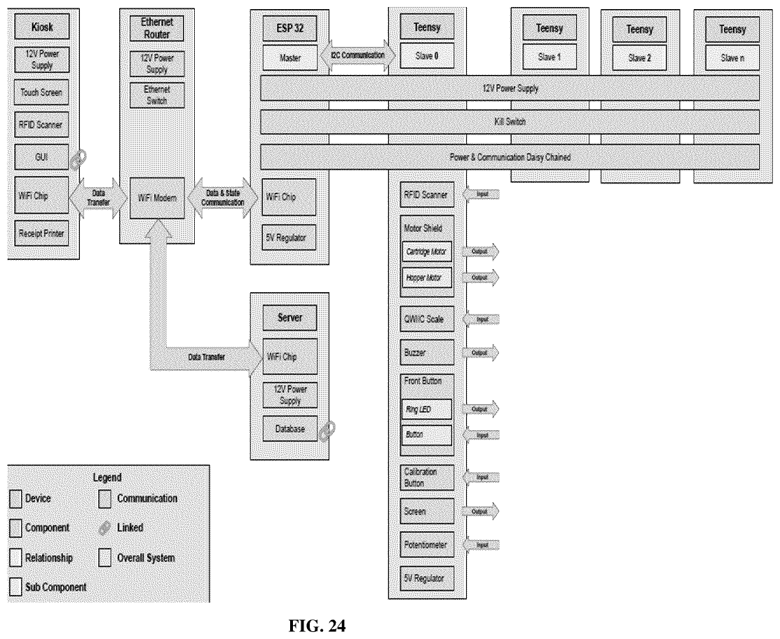

FIG. 24 is a block diagram illustrating components of a paddle feed system. According to FIG. 24, a paddle feed system consists of such modules or devices as a kiosk, ethernet router, server, ESP 32 microcontroller and multiple Teensy microcontrollers. The ESP 32 microcontroller acts as a master and the multiple Teensy microcontrollers are slaves (i.e., Slave 1, Slave2 . . . . Slave n). According to further disclosure, the Teensy microcontroller may be replaced with other microchips including AVR chip or others known to a person skill in the art.

According to FIG. 24, the kiosk module consists of such components as a 12V power supply, touchscreen, RFID scanner, graphical user interface (GUI), Wi-Fi chip/processor and a receipt printer. The ethernet router module consists of a 12V power supply, ethernet switch and Wi-Fi modem.

According to FIG. 24, the server module consists of a Wi-Fi chip, 12V power supply and a database. The ESP 32 module contains a 12V power supply, kill switch, a power & communication daisy chained, Wi-Fi chip and a 5V regulator. The Wi-Fi modem of the ethernet router communicates via data transfer with the Wi-Fi chips of the kiosk, ESP32 and server modules.

According to FIG. 24, the one or more Teensy modules contains a 12V power supply, kill switch, power & communication daisy chained with other modules, a RFID scanner, a motor shield, a QWIIC scale, a buzzer, a front button, a calibration button, a screen, a potentiometer and a 5V regulator. The motor shield further contains a cartridge motor and hopper motor subcomponents. The front button further contains a Ring LED and other buttons.

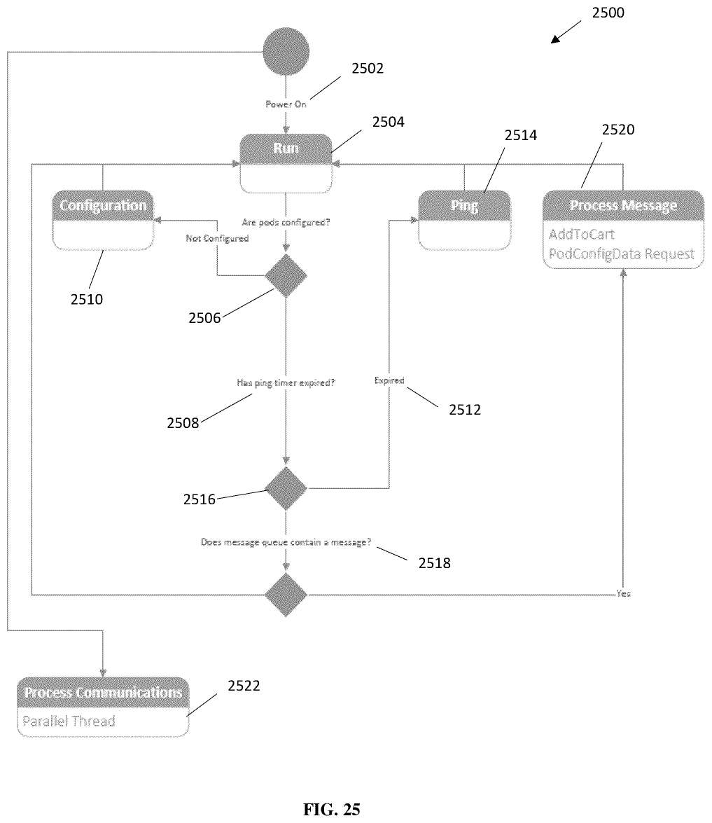

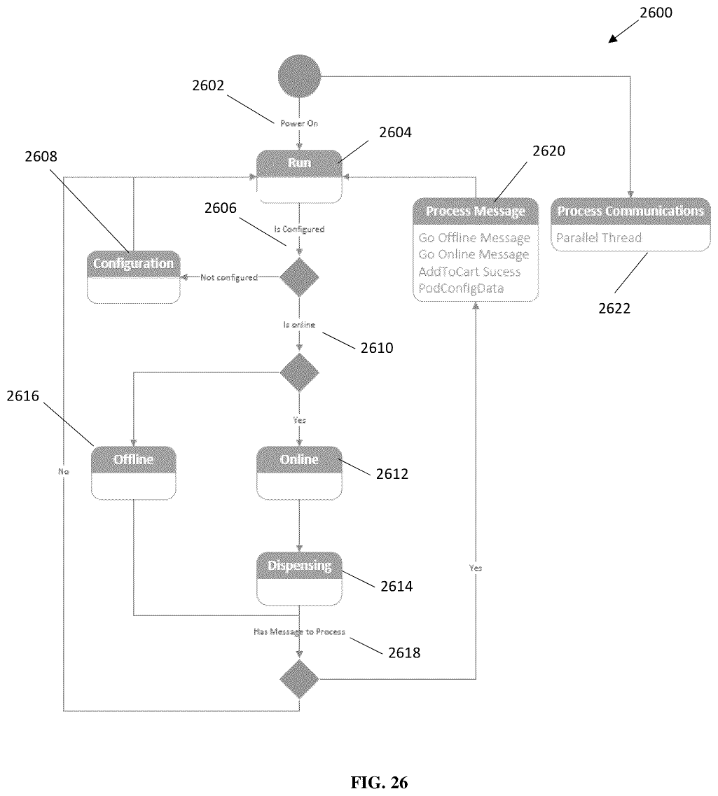

FIG. 25 is a state diagram illustrating dispensing activity of the system. According to FIG. 25, the system 2500 initiates with a Power On event at step 2502 at the Run state at step 2504. The system then determines whether the pods (or modules) are configured at step 2506. If it is configured, then the system determines whether a ping timer has expired at step 2508. If the pods are not configured, then the system moves to a Configuration state at step 2510 which then loops back to the Run state at step 2504.

According to FIG. 25, If the ping timer has expired at step 2512, the system will move to the Ping state 2514 and then loops back to the Run state at step 2504. However, if the latter is true (i.e., ping timer not expired) at step 2516, the system then further checks whether the message queue contains a message at step 2518. If the answer is Yes here (i.e., message queue contains a message), the system moves to the Process Message state at step 2520 which will execute the events of AddToCart and PodConfigData Request.

According to FIG. 25, if the answer is No (i.e., message queue does not contain a message) at step 2518, the system will return to the Run state for further processing at step 2504. Thereafter, a further state of Process Communication is executed as a parallel thread 2522.

FIG. 26 is a state diagram illustrating dispensing Teensy micro-controller activity of the system. According to FIG. 26, the system 2600 initiates with a Power On event at step 2602 where it proceeds to a Run state at step 2604. The Runs state checks whether the system is configured at step 2606. If it is not configured, the system then moves to the Configuration state at step 2608 and then loops back to the Run state at step 2604.

If the system is configured at step 2606, the system checks whether the system is online at step 2610. If the system is online at step 2610, it then proceeds to the Online state at step 2612 and then to the Dispensing state at step 2614. If the system is offline, it moves to the Offline state at step 2616, then jumps to the Dispensing state at step 2614.

According to FIG. 26, the system checks whether there is a message to process at the Dispensing state at step 2618. If there is a message to proceed, the system moves to the Process Message state at step 2620. The Process Message state at step 2620 contains functions to check for “Go Offline Messages”, “Go Online Messages”, “AddToCart Success” and “PodConfigData”.

According to FIG. 26, the system loops back to the Run state at step 2604. Furthermore, if the message to proceed is negative (e.g., No) at step 2618, the system also loops back to the Run state for further instructions at step 2604.

According to FIG. 26, a further state of Process Communication is executed as a parallel thread at step 2622.

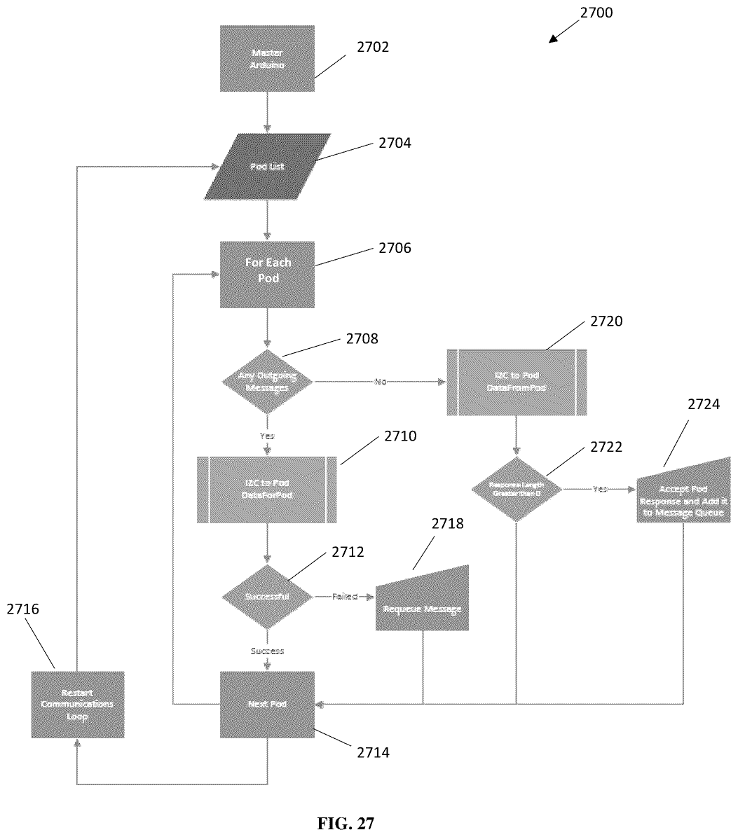

FIG. 27 is a flow chart illustrating communication steps of the system. According to FIG. 27, system 2700 initiates with Master Arduino at step 2702 where it moves onto the Pod List at step 2704 and then to For each Pod at step 2706. The system then checks to see if there any outgoing messages at step 2708. If Yes, the system proceeds to the step of 12C to Pod DataForPod at step 2710.

According to FIG. 27, the system then checks if it is successful at step 2712. If successful, then the system moves to the Next Pod at step 2714 and then to Restart Communication Loop at step 2716 where it returns to the PodList function at step 2704. If it is not successful (i.e., failed) at step 2712, the system then Requeues Message 2718, then moves to the Next Pod at step 2714.

According to FIG. 27, if the outgoing message is No at step 2708, the system then executes the command “I2C to Pod DatFromPod” at step 2720. The system then checks whether the “Response Length is greater than 0” at step 2722. If Yes, it then accepts Pod response and add it to Message Queue at step 2724. Thereafter, it then proceeds to the Next Pod at step 2714, then the Restart Communication Loop at step 2716. Finally, all processes at the Restart Communication Loop step returns to the Pod List at step 2704 command for further processing.

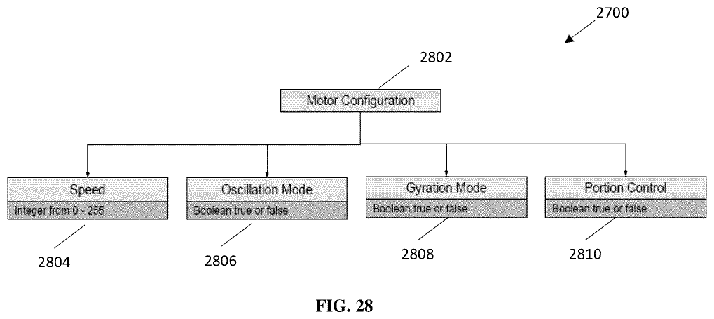

FIG. 28 is a state diagram illustrating various motor configurations. According to FIG. 28, state diagram 2700 illustrates the different states of the motor configuration 2802 including speed 2804 (ranging from 0-255), oscillation mode 2806 (chosen from Boolean true or false), gyration mode 2808 (chosen from Boolean true or false) and portion control 2810 (chosen from Boolean true or false).

According a preferred embodiment, one size of paddle rotor is currently used. It is anticipated that the number of fins and the diameter of the paddle will benefit from optimization for different materials.

According to the disclose, an automated product dispensing system for dispensing bulk food products is disclosed. The system comprises a power supply, a processor, a sealable cartridge module containing bulk food product, a first paddle rotor assembly mounted below the cartridge module to facilitate movement of the bulk food product, a hopper assembly detachably connected to the first paddle rotor assembly at the top end of the hopper assembly, a scale assembly detachably connected to the hopper assembly at the bottom end of the hopper assembly, a front display module, a frame configured to house the cartridge module, the first paddle rotor assembly, the hopper assembly, the scale assembly and the front display module. The hopper assembly further comprises a second paddle rotor assembly to facilitate movement of the bulk food product through the hopper assembly and the scale assembly to the front of the frame where the food can be dispensed.

According to the disclosure the hopper assembly further comprises a top retainer ring and bottom retainer ring. The first and second paddle rotor assembly further comprises a paddle rotor shaft and UHMW bearing in communication with the paddle rotor. The scale assembly further comprises a strain gauge, a load cell, a deflection limiter, a scale top cover, a scale bottom cover, a latch, a hirth coupling and a latch mirror.

According to the disclosure, the cartridge module further comprises a cartridge retaining mechanism (i.e., clip). The front display module further comprises a front viewing window, a back plate, a front face, an electronics cover and a latching mechanism. The cartridge assembly further comprises a cartridge, an O-ring, a lid and collar and a RFID tag.

According to the disclosure, the system can be hot swappable, wherein hot swappable means monitoring the connection to the blade connector and power rail.

According to the disclosure, a method for dispensing bulk food products, from an automated bulk product dispensing system is disclosed. The method comprising the steps of connecting first paddle assembly to a cartridge module of the system, loading the cartridge into the system, powering on the system, determining the system/pod configuration, measuring the weight of the hopper assembly, pre-filling the hopper with food product, receiving user input to dispense a certain amount of food product, loading the hopper assembly with a user-specified quantity of product, stopping the dispensing when reached proposed weight or price or if user let's go of button, measuring the weight of the remaining product in the hopper, sending card info to webapp (i.e., amount of product) and refilling hopper to maximum.

According to the disclosure, the user input of the method further comprises tapping a card and conducting a bar code scan. The amount entered of the method includes quantity of food product to dispense and is received from a mobile device for auto-dispense.

According to the disclosure, the method can dispense pre-set weight of product, wherein the pre-set weight is company controlled (portion control for employees (e.g., 100 g), pull per use).

According to the disclosure, a method to initiate card dispensing by a store for bulk food purchase, using an automated product dispensing system, the method comprising the steps of, receive RFID card configured to work with the automated product dispensing system (TagPod); activate the automated product dispensing system using the RFID card; dispense a desired amount of bulk food product, tap RFID card with product dispensing system kiosk, display total items dispense at the product dispensing system kiosk, print a user receipt, input the receipt info to a point of sales (POS) system to complete the purchase transaction and pay for purchase using a credit card at the POS system.

According to the disclosure, the RFID card of the method collects information on each use of the product dispensing system, and maintains a file on the card that is used to complete payment in a Point of Sale system. The RFID card collects information on each use of the product dispensing system, and maintains a file on a server or cloud system that is used to complete payment in a Point of Sale system.

According to the disclosure, the receipt of the method can be an itemized and or a master SKU. According to the disclosure, the step of checking out the purchase at the product dispensing system kiosk directly (skipping the POS system).

### GENERAL CONSIDERATIONS

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. An automated product dispensing system for dispensing bulk food products, the system comprising:
a power supply;
a processor;
a sealable cartridge module containing bulk food product;
a first paddle rotor assembly mounted below the cartridge module to facilitate movement of the bulk food product;
a hopper assembly detachably connected to the first paddle rotor assembly at the top end of the hopper assembly;
a scale assembly detachably connected to the hopper assembly at the bottom end of the hopper assembly;
a front display module; and
a frame configured to house the cartridge module, the first paddle rotor assembly, the hopper assembly, the scale assembly and the front display module;
wherein the hopper assembly further comprises a second paddle rotor assembly to facilitate movement of the bulk food product through the hopper assembly and the scale assembly to the front of the frame where the food can be dispensed.

2. The system of claim 1 wherein the hopper assembly further comprises a top retainer ring and bottom retainer ring.

3. The system of claim 1 wherein the first and second paddle rotor assembly further comprises a paddle rotor shaft and UHMW bearing in communication with the paddle rotor.

4. The system of claim 1 wherein the scale assembly further comprises a strain gauge, a load cell, a deflection limiter, a scale top cover, a scale bottom cover, a latch, a hirth coupling and a latch mirror.

5. The system of claim 1 wherein the cartridge module further comprises a cartridge retaining mechanism.

6. The system of claim 1 wherein the front display module further comprises a front viewing window, a back plate, a front face, an electronic cover and a latching mechanism.

7. The system of claim 1 wherein the cartridge assembly further comprises a cartridge, an O-ring, a lid and collar and a RFID tag.

8. The system of claim 1 wherein the system can be hot swappable.

9. The system of claim 8 wherein the system is hot swappable by monitoring the connection to the blade connector and power rail.

10. A method for dispensing bulk food products, from an automated bulk product dispensing system, the method comprising the steps of:
connecting first paddle assembly to a cartridge module of the system;
loading the cartridge into the system;
powering on the system;
determining the system configuration;
measuring the weight of the hopper assembly;
prefilling the hopper with food product;
receiving user input to dispense a certain amount of food product;
loading the hopper assembly with a user-specified quantity of product;
stopping the dispensing when reached proposed weight or price or if user let's go of button;
measuring the weight of the remaining product in the hopper;
sending card info on the amount of product dispensed to a web application; and
refilling the hopper to a maximum quantity.

11. The method of claim 10 wherein the user input further comprises tapping a card and conducting a bar code scan.

12. The method of claim 10 wherein the amount entered is received from a mobile device for auto-dispensing.

13. The method of claim 10 wherein the system can dispense pre-set weight of product, wherein the pre-set weight is company controlled for portion control.

14. A method to initiate card dispensing by a store for bulk food purchase, using an automated product dispensing system, the method comprising the steps of:
receiving a RFID card configured to work with the automated product dispensing system;
activating the automated product dispensing system using the RFID card;
dispensing a desired amount of bulk food product;
tapping the RFID card with product dispensing system kiosk;
displaying the total items dispense at the product dispensing system kiosk;
printing a user receipt;
inputting the receipt info to a point of sales (POS) system to complete the purchase transaction; and
paying for purchase using a credit card at the POS system.

15. The method of claim 14 whereby the RFID card collects information on each use of the product dispensing system and maintains a file on the card that is used to complete payment in a Point of Sale system.

16. The method of claim 14 whereby the RFID card collects information on each use of the product dispensing system and maintains a file on a server or cloud system that is used to complete payment in a Point of Sale system.

17. The method of claim 14 wherein the receipt can be an itemized and or a master stock keeping unit (SKU).

18. The method of claim 14 further comprising the step of checking out the purchase at the product dispensing system kiosk directly.
